(19) United States
(12) Patent Application Publication
(10) Pub. No.: US 2008/0100083 A1
(43) Pub. Date: May 1, 2008

(54) FLOATING LINER MOUNT ATTACHMENT AND METHOD

(76) Inventor: Paul E. BARCLAY DE TOLLY, Portsmouth, RI (US)

Correspondence Address: PILLSBURY WINTHROP SHAW PITTMAN, LLP, P.O. BOX 10500, MCLEAN, VA, 22102, US

(21) Appl. No.: 11/554,622

(22) Filed: Oct. 31, 2006

(51) Int. Cl. B62D 33/00

(52) U.S. Cl. 296/39.2

(57) ABSTRACT

A mounting system is provided for reducing binding effects that includes a first rail and a second rail. The mounting system also includes a first mount and a second mount that are coupled to each other. The first mount is configured to engage with the first rail in a sliding manner generally along a first longitudinal axis. A liner is positioned between the second mount and the second rail and is configured to permit the second rail to slide within the second mount generally along a second longitudinal axis spaced from and substantially parallel to the first longitudinal axis. The liner is also configured to permit relative movement between the second mount and the second rail in a transverse direction transverse to the second longitudinal axis during sliding of the second mount generally along the second longitudinal axis.

### FIELD OF THE INVENTION

The present invention relates to mounting assemblies and, more particularly, to a mounting assembly that reduces binding effects.

### BACKGROUND OF THE INVENTION

Conventional truck bed accessories are typically attached to rail tracks by sliding a slotted mount over an end of a track. The mount and accessory are then slid along the track until they reach their final position. Due to nonconformities in the vehicle, rail, or track, however, sliding mounts may run into problems such as, for example, binding, derailment, or blockage. In cases where accessories have two mounts coupled thereto, each sliding onto opposite rails on a truck bed, a small defect may result in the rails becoming nonparallel and cause the accessory mounts to bind, preventing attachment.

### SUMMARY OF THE INVENTION

In accordance with an embodiment of the present invention, a mounting system is provided for reducing binding effects that includes a first rail and a second rail. The mounting system also includes a first mount and a second mount that are coupled to each other. The first mount is configured to engage with the first rail in a sliding manner generally along a first longitudinal axis. A liner is positioned between the second mount and the second rail and is configured to permit the second rail to slide within the second mount generally along a second longitudinal axis spaced from and substantially parallel to the first longitudinal axis. The liner is also configured to permit relative movement between the second mount and the second rail in a transverse direction transverse to the second longitudinal axis during sliding of the second mount generally along the second longitudinal axis.

In accordance with another aspect of the present invention, a method is provided for mounting an object to a rail in which a liner is slid onto a rail along a longitudinal axis and a mount is slid onto the rail along the longitudinal axis. The mount and the liner are configured to permit movement, during sliding, of the mount relative to the rail in at least one direction transverse to the longitudinal axis.

Other objects, features, and advantages of the present invention will become apparent from the following detailed description, the accompanying drawings, and the appended claims.

### BRIEF DESCRIPTION OF THE DRAWINGS

The above-mentioned and other features and advantages of this disclosure, and the manner of attaining them, will become more apparent and the disclosure itself will be better understood by reference to the following description taken in conjunction with the accompanying drawings, wherein:

FIG. 1 is a perspective view of a vehicle truckbed in accordance with an embodiment of the present invention;

FIG. 2 is an exploded perspective view of a mount assembly in accordance with an embodiment of the present invention;

FIG. 3 is a cross sectional view of a mount assembly and rail in accordance with an embodiment of the present invention;

FIG. 4 is a detail cross sectional view of a mount assembly and rail track in accordance with an embodiment of the present invention;

FIG. 5 is a detail cross sectional view of a mount assembly and rail track in accordance with another embodiment of the present invention;

FIG. 6 is a partial cross sectional view of a mount assembly with a locking knob in accordance with an embodiment of the present invention;

FIG. 7 is a schematic diagram of an accessory for mounting on parallel rails in accordance with an embodiment of the present invention;

FIG. 8 is a cross sectional view of a movement restricting mounting assembly in accordance with an embodiment of the present invention; and

FIG. 9 is a cross sectional view of a movement restricting mounting assembly in accordance with another embodiment of the present invention.

An embodiment will be described with reference to the accompanying drawings. Corresponding reference characters indicate corresponding parts throughout the several views. The description as set out herein illustrates an arrangement of an embodiment of the present disclosure and is not to be construed as limiting its scope in any manner.

### DETAILED DESCRIPTION OF THE INVENTION

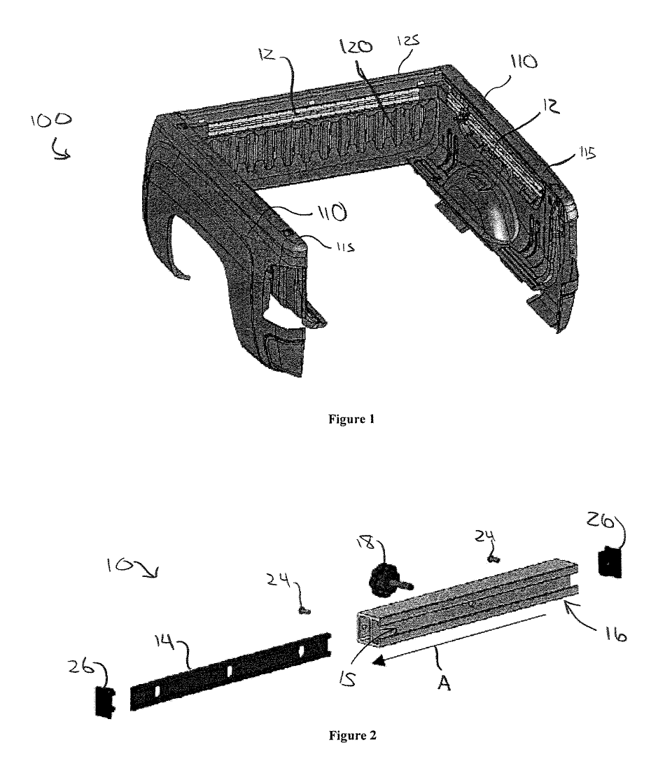

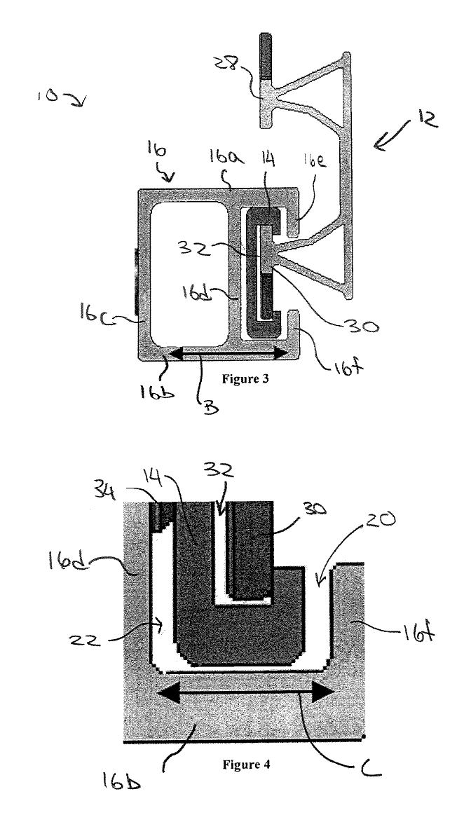

FIG. 1 shows a vehicle truckbed 100 suitable for use in the present invention. One of skill in the art will appreciate, however, that the present invention may be applied to a great variety of applications including, but not limited to, objects and vehicles onto which substantially parallel rails may be installed to receive sliding accessory or other object mountings. As shown in FIG. 1, the truckbed includes two side panels 110 and a rear or tailgate panel 120. Rails 12 are fixedly mounted on the inside of each of the panels (110, 120). Although not shown, it is appreciated that rails 12 may additionally or alternatively be fixedly mounted to a top portion 115 of the side panels 110 and/or a top portion 125 of the rear panel 120. The rails 12 may be of a “T-track” type that has one, two, or several attachment tracks 28, 30 (see FIG. 3) for receiving a mount 10, which slides along the rail 12 generally along a common longitudinal axis. Conventional mounts for attachment to such rails typically have slots that are slid longitudinally onto the rail tracks at each of their respective ends. The conventional mount is then slid along the track until it reaches its final location. Reference may be made to the sliding overhead racks in U.S. Pat. Nos. 5,494,327 and 6,547,311, the entirety of which are incorporated herein by reference.

As shown in FIG. 2, a mount assembly 10 for slidingly mounting to a rail 12 in accordance with the present invention includes a mount frame 16 and a liner 14. The mount assembly 10, in alternative embodiments, may further include end caps 26, end cap fasteners 24, and knob 18. As shown in FIG. 2 and in cross-section in FIG. 3, the frame 16 may include a top wall 16a, a bottom wall 16b, a side wall 16c, a medial wall 16d, an upper flange 16e, and a lower flange 16f. As shown, a portion of the top wall 16a, the medial wall 16d, the upper flange 16e, and the lower flange 16f are configured to form a C-shape and to enclose a space 15. The space 15 is configured to slidingly receive the track portion 30 of the rail 12 with excess space between the walls of the frame 16 and the track.

To attach the mount assembly 10 to a rail 12 with a track 30 (and/or 28), the liner 14 may be slid onto the track 30. As shown in FIG. 3, the liner 14 substantially conforms to the vertical width dimension of the track 30 and may optionally be sized to allow a space 32 between the liner 14 and the track 30, also shown in detail in FIG. 4. Then, the mount frame 16 is slid longitudinally along the track 30 with liner 14 until it reaches its final position. During the sliding movement of the mount 16 along the track 30, the excess portions of space 15 on opposing sides of the liner 14 allows the frame 16 to move freely in a direction C, as shown in FIG. 4, which is transverse to a common sliding longitudinal axis of the track 30 and frame 16. As shown, the space 22 between medial wall 16d and the liner 14, the space 20 between the liner 14 and the flange 16f, and the space 32 between the track 30 and the liner 14 are all configured to permit movement of the frame 16 in the transverse direction C relative to the track 30.

End caps 26 may then be inserted into the ends of the frame 16 in order to provide protection and/or for aesthetic purposes. The end caps 26 may be secured by end cap fasteners 24. The end caps 26 may be configured to cover parts of the longitudinal ends of space 15 to partially entrap the liner 14.

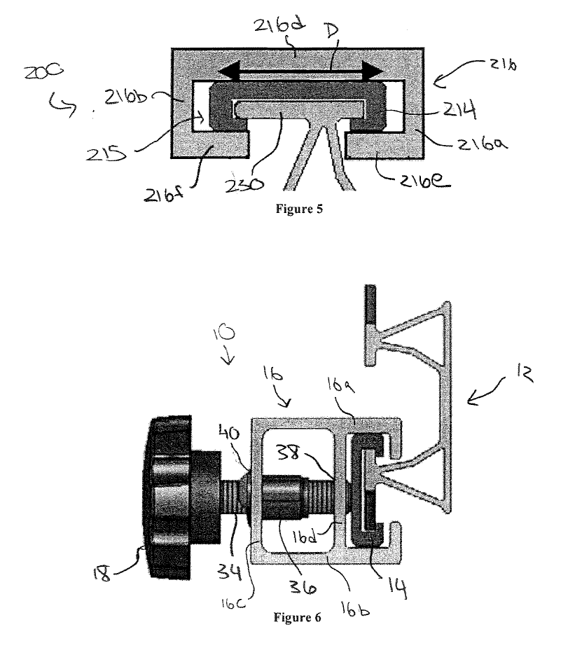

As shown in FIG. 6, the frame 16 may be further secured to the rail 12 by inserting a threaded bolt 34, connected to locking knob 18, into hole 40 in the wall 16c and hole 38 in medial wall 16d to abut a surface of the liner 14, as shown. The holes 40 and/or 38 may be threaded for tightening the bolt 34, or a threaded nut 36 may be provided for tightening the bolt 34. In this manner, the mount frame 16 may be held against the liner 14 and the track 30 in a secure position against longitudinal movement. Any type of fastener for providing a forced engagement between the frame 16, the liner 14 and the track 30 may be used.

In one embodiment, shown in FIG. 5, a track 230 may instead be oriented with its width in a horizontal direction. In this embodiment, a frame 216 that is mounted to the horizontally oriented track 230 forms a C-shaped space 215 that is open in a downward direction instead of the sideways direction shown in FIGS. 2 and 3. This embodiment may be applicable, for example, in configurations in which tracks 12 are mounted on a top surface 115 of truckbed side panels 110. The end caps 26 and locking knob 18 may be used in this embodiment in a manner similar to that described above.

In one embodiment, the liner 14 may be configured to substantially conform to the track 12 in a horizontal direction and provide a space in the vertical direction, or be configured to provide spaces in both the horizontal direction as well as the vertical direction for increased tolerance of inconsistencies or defects in the rails 12 or frames 16.

Although the method described above refers to sliding the liner 14 onto the track 30 prior to sliding the frame 16 onto the liner 14, one of skill in the art will appreciate that the liner 14 may instead be first inserted into the space 15 of the frame 16. Then, together with the frame 16, the liner may be slid onto the track 30. Performing the method in this manner likewise permits movement of the frame 16 relative to the track 30 in a manner similar to that described above.

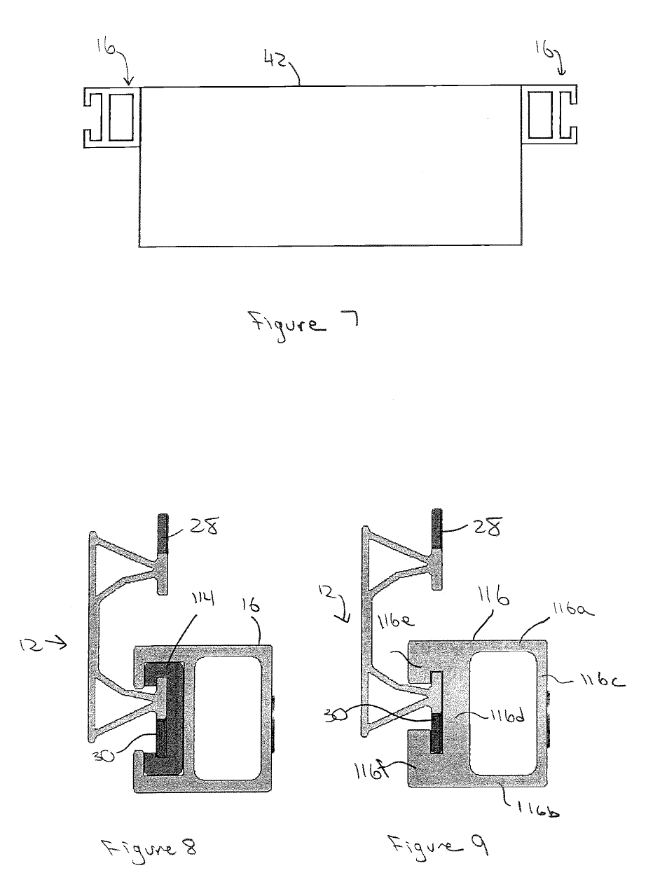

In use, the mount assembly 10 described above may be part of an accessory 42, as shown in FIG. 7, or other apparatus that simultaneously attaches to a pair of rails 12 that are substantially parallel, such as the rails 12 along the two side panels 110 of the vehicle truckbed 100, as shown in FIG. 1. The accessory 42 may be, for example, a tonneau cover, a toolbox or other tool container, rack, or mount, a ladder rack, a sporting equipment rack, a glass panel rack, a truckbed cap or shell, etc. In such an application, the accessory 42 to be mounted may include two sliding mount frames 16 that are coupled to each other through the body of the accessory 42. One of the mount frames 16 may be part of a mount assembly that slides along one of the rails 12 without permitting movement in a transverse direction to the common sliding longitudinal axis, such as a mount assembly as shown in FIG. 8 or FIG. 9. In those embodiments, no excess space is provided for permitting movement between the rail and the frame. The other mount frame 16 may also be part of a mount assembly that permits relative movement between the frame 16 and the track 30 in a direction transverse to the common sliding longitudinal axis, such as that described above with respect to FIGS. 3 and 4.

As shown in FIG. 8, a mount frame 16 is part of a mount assembly that does not permit substantial relative movement between the frame 16 and the track 30 in a direction transverse to the sliding direction, or common sliding longitudinal axis. As shown, a liner 114 is configured such that there is little or no excess space between the frame 16 and the liner 114 or between the liner 114 and the track 30. Accordingly, any transverse movement is substantially restricted by virtue of the liner 114 taking up excess space between the frame 16 and the track 30.

FIG. 9 shows another embodiment of a mount assembly that restricts relative movement between a sliding mount frame and a rail track in a direction transverse to the sliding direction. As shown, a mount frame 116 is provided that substantially conforms to the dimensions of the track such that there is little or no space therebetween. In the illustrated embodiment, the frame walls 116d, 116e, and 116f are thickened relative to the embodiment shown in FIG. 8, but one of skill in the art will appreciate that the walls need not be thickened in order to conform to the shape of the track. For example, the mount frame 116, or at least the portion of the frame 116 that engages the track 30 may simply be made smaller and/or more compact to more closely fit the dimensions of the track 30. Accordingly, the embodiment shown in FIG. 9 likewise restricts relative movement between a mount frame and a rail track in a direction transverse to the sliding direction. These examples of limiting relative movement between a mount frame and a track are merely illustrative and one of skill in the art would appreciate that a great variety of configurations of mount assemblies may be used to limit such movement and are within the scope of the present invention.

In one embodiment, an accessory 42 may include mount assemblies 10 that are both configured to permit relative movement between the mount frame 16 and the track 30 in a direction transverse to a common sliding longitudinal axis. In this case, both mount assemblies are configured in accordance with the embodiments shown in FIGS. 2-6, including the modifications and adaptations known to those skilled in the art.

It should be understood that any directional references (e.g., up, down, top, bottom, left, right, etc.) have been used for convenience and with reference to the accompanying Figures. These should not be regarded as limiting. The invention and/or any embodiment thereof may be practiced in various orientations, and no particular directions are essential.

While specific embodiments have been described above, it will be appreciated that the subject of the present disclosure may be practiced otherwise than as described. The descriptions above are intended to be illustrative, not limiting. Thus, it will be apparent to one skilled in the art that modifications may be made without departing from the scope of the claims set out below.

What is claimed is:

1. A mounting system for reducing binding effects, comprising:
a first rail and a second rail;
a first mount and a second mount, the mounts being coupled to each other;
wherein the first mount is configured to engage with the first rail in a sliding manner generally along a first longitudinal axis, and
wherein a liner is positioned between the second mount and the second rail, the liner being configured to permit the second rail to slide within the second mount generally along a second longitudinal axis spaced from and substantially parallel to the first longitudinal axis, the liner further configured to permit relative movement between the second mount and the second rail in a transverse direction transverse to the second longitudinal axis during sliding of the second mount generally along the second longitudinal axis.

2. The mounting system of claim 1, wherein the first rail is configured to slide within the first mount such that there is substantially no relative movement between the first rail and the first mount in a direction transverse to the longitudinal axis.

3. The mounting system of claim 1, wherein the second mount has a C-shaped cross-section in a portion that receives the second rail, the C-shaped portion forming a space that is substantially occupied by the liner in a third direction transverse to both the second longitudinal axis and the transverse direction, and provides excess space in the transverse direction.

4. The mounting system of claim 1, further comprising a fastener that engages with a surface of the liner to create a forced engagement between the second mount, the liner, and the second rail to secure the mount against longitudinal movement along the rail.

5. The mounting system of claim 4, wherein the fastener is rotatable.

6. The mounting system of claim 1, further comprising at least one end cap disposed at least at one end of the first mount or one end of the second mount.

7. The mounting system of claim 1, wherein the first rail and the second rail are each mounted on respective inner sides of two vehicle truckbed side panels.

8. The mounting system of claim 1, wherein the first rail and the second rail are each mounted on respective top portions of two vehicle truckbed side panels.

9. The mounting system of claim 1, wherein the first rail and the second rail are coupled to each other by a vehicle accessory.

10. A method for mounting an object to a rail, comprising:
sliding a liner onto a rail along a longitudinal axis;
sliding a mount onto the rail along the longitudinal axis;
wherein the mount and liner are configured to permit movement, during sliding, of the mount relative to the rail in at least one direction transverse to the longitudinal axis.

11. The method of claim 10, wherein the liner is slid into a space in the mount prior to being slid onto the rail.

12. The method of claim 10, wherein the mount is a first mount and the rail is a first rail, and further comprising sliding a second mount onto a second rail along a second longitudinal axis along with the sliding of the first mount onto the first rail.

13. The method of claim 12, wherein the second mount and the second rail are configured such that there is substantially no relative movement between the second mount and the second rail in a direction transverse to the second longitudinal axis.

14. The method of claim 10, further comprising using a fastener to create a forced engagement between the mount, the liner, and the rail to secure the mount against longitudinal movement along the rail.
